(19) United States
(12) Patent Application Publication
(10) Pub. No.: US 2024/0242211 A1
(43) Pub. Date: Jul. 18, 2024

(54) JURISDICTIONAL LOGIC SYSTEM

(71) Applicant: EVEREST NETWORK LTD., San Diego, CA (US)

(72) Inventors: Bradley James Witteman, Vancouver, WA (US); Michael Dean Kail, Los Gatos, CA (US)

(73) Assignee: EVEREST NETWORK LTD., San Diego, CA (US)

(21) Appl. No.: 18/689,826

(22) PCT Filed: Oct. 14, 2021
(86) PCT No.: PCT/US2021/054878

§ 371 Date: Mar. 6, 2024

(51) Int. Cl. G06Q 20/40

(52) U.S. Cl. CPC G06Q 20/401

(57) ABSTRACT

Described is a method and system for automating financial regulatory compliance. The described subject generates a jurisdictional definition file based on a plurality of financial regulatory requirement for a plurality of countries. Responsive to receiving a transaction request, the method and system further generate a configurable transaction array for the transaction request that is a subset of the jurisdictional definition file based on a sender information and a receiver information. The jurisdiction logic system and method described above further maps the sender information and the receiver information into the configurable transaction array. Lastly, the jurisdiction logic system determines whether the transaction request will succeed or fail by using a decision tree that is populated by the configurable transaction array.

### FIELD

This disclosure relates to automating the financial regulatory compliance process. More particularly, this disclosure relates to providing remediation steps that may be required for proceeding a financial transaction between two people that live in different countries.

### BACKGROUND

Performing a financial transaction from one country to another country can be crucial since it is overshadowed by country-based regulations. Different countries have different banking regulations and legislations, and regulatory bodies around the world usually require extra information or additional forms/documents to complete and finalize the transaction. There continues to be a genuine need for a system and a method that automates this complex international regulatory compliance process when making a financial transaction between two countries.

### SUMMARY

The present disclosure includes a method and system for automating financial regulatory compliance. In an exemplary embodiment, the described method generates, by a mapping system, a jurisdictional definition file based on a plurality of financial regulatory requirements for a plurality of countries. Responsive to receiving a transaction request, the method generates a configurable transaction array for the transaction request that is a subset of the jurisdictional definition file based on a sender information and a receiver information. The sender information includes a sender identification information, a sender country, and a type of transaction. The receiver information includes a receiver identification information, and a receiver country. The configurable transaction array also includes a series of logic step questions to extract information regarding the sender country, receiving country, reason of transaction, type of currency, and other details associated with the transaction. The proposed method maps the sender information and the receiver information into the configurable transaction array. The method further determines whether the transaction request will succeed or fail by using a decision tree that is populated by the configurable transaction array. Responsive to determining that the transaction will fail further, the method determines the remediation steps that will be required for the transaction to proceed. Responsive to determining that the transaction will succeed, the method performs the transaction request. The described method also updates the jurisdictional definition file as the underlying configurable transaction array files are modified whenever there is a change in the financial regulatory requirement.

The present disclosure also includes a system for automating financial regulatory compliance. In another exemplary embodiment, a mapping system is configured to generate a jurisdictional definition file based on a plurality of financial regulatory requirements for a plurality of countries. Responsive to receiving a transaction request, a jurisdiction logic system is configured to generate a configurable transaction array for the transaction request that is a subset of the jurisdictional definition file based on a sender information and a receiver information. The sender information includes a sender identification information, a sender country, and a type of transaction. The receiver information includes a receiver identification information, and a receiver country. The configurable transaction array component also includes a series of logic step questions to extract information regarding the sender country, receiving country, reason of transaction, type of currency, and other details associated with the transaction. The proposed jurisdiction logic system is configured to map the sender information and the receiver information into the configurable transaction array. The jurisdiction logic system is further configured to determine whether the transaction request will succeed or fail by using a decision tree that is populated by the configurable transaction array. Responsive to determining that the transaction will fail, the system determines the remediation steps that will be required for the transaction to proceed. Responsive to determining that the transaction will succeed, the system performs the transaction request. The system also updates the jurisdictional definition file as the underlying configurable transaction array files are modified whenever there is a change in the financial regulatory requirement.

The present disclosure also includes a method for automating financial regulatory compliance. In an exemplary embodiment, the method includes generating, by a mapping system, a jurisdictional definition file based on a plurality of financial regulatory requirements for a plurality of countries and, responsive to receiving a transaction request, generating, by a jurisdiction logic system, transaction data comprising one or more questions that are based on a sender information and a receiver information of the transaction request.

The method includes determining that the transaction request will succeed or fail based on a decision tree that is generated from the transaction data. The method may further include identifying one or more customers in the transaction data and performing a source wealth analysis on the one or more customers. The method may further include determining a risk score based on the source wealth analysis for the one or more customers and determining that the risk score is below a threshold to proceed with the transaction request. The method may further include determining whether a transaction request can be remedied responsive to a determination that the transaction request will fail. The method may further include determining one or more remedial steps based on the determination that the transaction request will fail. The remedial steps may include providing additional transaction information for the transaction request. The transaction request may include an array of two or more transactions.

### BRIEF DESCRIPTION OF THE DRAWINGS

The following figures show embodiments according to the inventive subject matter. Certain features of various embodiments of the present technology are set forth with particularity in the appended claims. A better understanding of the features and advantages of the technology will be obtained by reference to the following detailed description that sets forth illustrative embodiments, in which the principles of the present disclosure are utilized, and the accompanying drawings of which:

FIG. 1 is a schematic system diagram illustrating the hardware components that may be used to implement various features of embodiments described in the present disclosure.

FIG. 2 is a flow diagram of a process for automating financial regulatory compliance.

FIG. 3 illustrates the data elements that the system needs in order to start creating the configurable transaction array.

FIG. 4 illustrates the jurisdiction logic system mapping the transaction details into the configurable transaction array.

FIG. 5 illustrates an overview of the configurable transaction array.

FIG. 6A illustrates an example of a configurable transaction array being conducted.

FIG. 6B illustrates further details regarding the previous example of a configurable transaction array being conducted.

FIG. 7 illustrates a decision tree that is populated by the configurable transaction array.

### DETAILED DESCRIPTION

A system and method for automating financial regulatory compliance. The proposed subject matter describes an automated system for defining and enforcing varying financial jurisdictional environments by mapping the Financial Regulatory Framework into a coded definition file per regulatory environment. The system then takes the Origin and Destination files, combines them into a transaction array, and applies the parameters of the transaction to the transaction array to define what actions are required to satisfy the Regulatory Framework. The process is driven by the parameters of a specific user-defined transaction, which defines the transaction array, in combination with a decision tree of various actions, requirements and outcomes possible for each transaction.

Additionally, the proposed method will be used for cataloging the regulatory environment for financial transactions in a way that is standardized and then vended as a service to other financial institutions. The system is dynamic based upon the transaction being proposed as defined by the origin location, sending individual, destination location, receiving individual, transaction amount, and a variety of other factors. By consuming the regulatory environments and distilling them into a multi-faceted definition, the system creates a process that automates the collection of various documents, identification, and proof from the users—sender and receiver. Moreover, the system is updated as the underlying transaction arrays files are modified whenever there is a change in the financial regulatory requirement.

For example, a person from Paris wishes to send 250 EUR to Sweden. The proposed system and method enforce KYC for the sender and the receiver as defined by the transaction array. So the person in France would need to produce sufficient identification to satisfy EU Know Your Customer (KYC) regulations (Passport, Driver's License, National ID) and the recipient in Sweden would also need to produce identification to satisfy the EU KYC regulation prior to the money being dispersed. In another example, a person from Paris wishes to send 250 EUR to Iran. The system is informed by various “Sources of Truth” for information such as the UN Consolidated Sanctions List and other Sanction Lists. Iran is on sanctions list. Therefore, the system informs the Agent that the transaction is not allowed and exits. In the above examples, Remittance Transaction process is initiated by a User, or Agent on User's behalf. The Recipient is defined by the User (sender). Origin of Transaction is the Agent's Location as defined by their place of business and corresponding license, or the User's Location as defined by their residential address. Destination of Transaction is defined by the recipient institution, their place of business and corresponding license, or the User's Location as defined by their residential address. There are a series of different parameters such as: Purpose of Transaction, Source of Funds, CIP/KYC (know your customer)/CDD (customer due diligence)/EDD (enhanced due diligence) definitions and thresholds, etc.

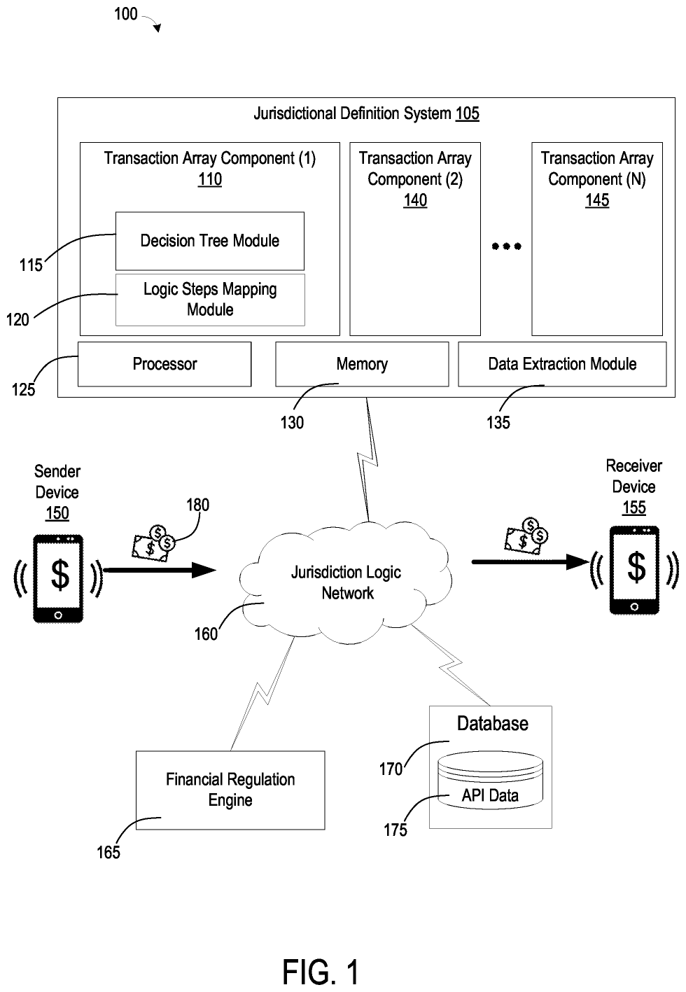

Referring to FIG. 1, FIG. 1 is a schematic diagram of the jurisdictional system 100 illustrating the hardware components that may be used to implement various features of embodiments described in the present disclosure. One of the purposes of the jurisdictional system 100 is to illustrate the hardware components that may be used. The jurisdictional system 100 includes, jurisdictional definition system 105, sender device 150, receiver device 155, jurisdiction logic network 160, financial regulation engine 165, database 170, and a financial transaction 180. The jurisdictional system 100 may facilitate a transaction from a sender device 150 to a receiver device 155 through the jurisdiction logic network 160. Further, the jurisdictional system 100 may determine whether the transaction violates or likely violates one or more regulations. Accordingly, the jurisdictional system 100 may flag requested transactions that are likely to fail. The flagged transactions may be halted, thus preventing costly issues associated with a transaction that violates one or more regulations.

The jurisdictional system 100 may include one or more computer hardware systems. In some embodiments, it may be implemented using a client server architecture or a distribution computational model. In other embodiments, it may be implemented in a SaaS model or a cloud server model. Through the different embodiments, the one or more computer hardware systems may be a set of integrated devices that input, output, process, and store data and information. The one or more computer hardware systems may further receive and process data according to the instructions given to it, and after the data has been processed, the results of the processing are usually sent to an output device.

The jurisdictional definition system 105 includes a processor 125, memory 130, data extraction module 135, and multiple transaction arrays—transaction array component 110, transaction array (2) 140, and so on to transaction array (N) 145. Each transaction array comprises of a decision tree module 115 and a logic steps mapping module 120. The logic step mapping module 120 maps the sender device 150 information and the receiver device 155 information into the described transaction arrays. The decision tree module 115 uses a tree-like model of decisions and their possible consequences and outcomes. One of the purposes of the decision tree module 115 is to automate the financial regulatory compliance by processing conditional control statements that gets populated with the data that is extracted through the data extraction component 135. The data extraction component 135 retrieves data out of data sources for further data processing or data storage. The data that gets retrieved through the data extraction component 135 comprises the information of the sender device 150, receiver device 155, reason of transaction, type of currency, and other details associated with the transaction. The jurisdictional definition system 105 also includes a processor 125. The processing unit is the electronic circuitry unit within this technology that executes and performs logic, arithmetic, input/output operations specified by the jurisdictional definition system 105, and the data analytics algorithms regarding the information that is extracted from the data extraction component 135. The information that is processed through the processor 125 is later saved in the memory 130 which is the internal storage area in the jurisdictional definition system 105.

Additionally, the jurisdictional definition system 105 is linked with the financial regulation engine 165 and the database 170 through the jurisdiction logic network 160. As time goes on, and various transactions get processed through this system, these transaction arrays are refreshed and updated, and the data gets saved in the database 170. The database 170 is an organized collection of data that is accessed through the jurisdiction logic network 160 through formal design and modeling techniques. The databased 170 includes an API data 175 which is the computing interface that defines interactions between various components involved in this system and method. Lastly, the financial regulation engine 165 is where all the international fund transferring regulations are stored and processed. The financial regulation engine 165 is the component that executes one or more rules in a runtime production environment that might come from various regulatory bodies within different countries. When the database 170, financial regulation engine 165, and the jurisdictional definition system 105 are successfully operating, the sender device 150 will be able to make a financial transaction 180 to a receiver device 155 while having the jurisdiction logic network 160 take care of the regulation compliance.

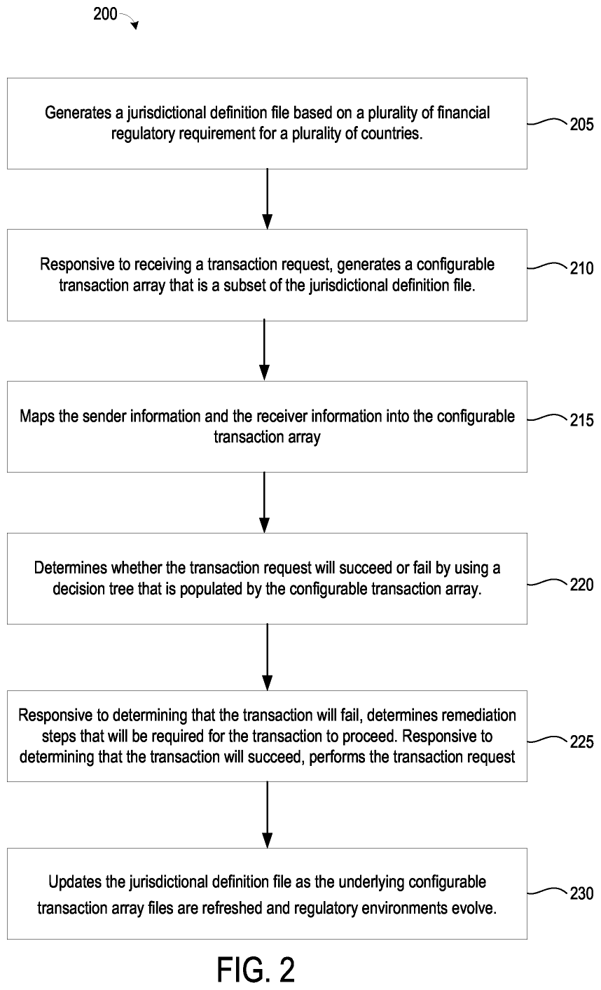

Referring to FIG. 2, FIG. 2 is a flow diagram 200 regarding a process for automation of financial regulatory compliance. At step 205, the system generates a jurisdictional definition file based on a plurality of financial regulatory requirements for a plurality of countries. The system generates this jurisdictional definition file by accessing the processor 125, and the data extraction module 135, and the financial regulation engine 165. The information in this generated jurisdictional definition file is first stored in the memory 130 and then it is further transferred to the database 170 once a transaction is processed and completed.

At step 210, responsive to receiving a transaction request, the system generates a configurable transaction array that is a subset of the jurisdictional definition file. The configurable transaction array contains financial regulatory data that is relevant to the transaction request. For example, a transaction request to transfer money from Kyoto, Japan to London, UK, would generate a configurable transaction array containing Japanese export regulations and United Kingdom import regulations. The configurable transaction array may further include questions or queries for the information needed to complete a successful transaction from sender to receiver. For instance, a query may request details of the transaction request such as the identity of the parties, the purpose of the transaction, the products or services being purchased, the amount of the transaction, the time of the transaction, similar past transactions, and the planned frequency of transactions.

A query may further request whether the transaction is part of a larger deal. As such, the larger deal, which may include additional transactions, may have bearing on the transaction request. The configurable transaction array may condition approval of the transaction request on a prior approval of one or more transactions that are related to the transaction request. For example, a project may require two or more successful interstate transactions to be completed. Thus, the configurable transaction array may include one or more conditions for which other transactions within the same project must also be approved before the transaction request can itself be approved. The transaction array component 110 can be responsible for this jurisdiction definition file generation.

At step 215, the system maps the sender information and the receiver information into the configurable transaction array using the logic steps mapping module 120. The mapping may be directed by the query or questions that were generated by the configurable transaction array. In various embodiments, sender and receiver information may be automatically retrieved from available databases. For example, where the sender and receiver are registered corporations, information on the sender and receiver that is relevant to the requested transaction may be publicly available.

The configurable transaction array generates a decision tree based on the regulations of the source location and destination location of the requested transaction. The decision tree includes a multitude of nodes where each node represents a decision to be made. The initial node branches to two or subsequent decision nodes. The decision at a node may be condition. For example, a decision may specify a threshold for an amount of the transaction request. Responsive to whether amount of the transaction request surpasses the threshold, the node will propagate the decision to one of the two subsequent attached nodes of the decision tree. At step 220, the system can determine whether the transaction request will succeed or fail by using the decision tree that is populated by the configurable transaction array. This determination happens through the hardware component decision tree module 115.

At step 225, responsive to determining that the transaction will fail, the system determines remediation steps that will be required for the transaction to proceed. In various embodiments, the system may specify specific criteria that resulted in the determination that the requested transaction would fail. In an exemplary embodiment where government regulations prohibit modification of transactions to get around regulatory bans or embargoes, the system may withhold remediation steps that could result in legal jeopardy for the sending or receiving parties.

Moreover, responsive to determining that the transaction will succeed, the system performs the transaction request. The system is able to make this determination through the decision tree module 115 which uses a tree-like model of decisions and their possible consequences and outcomes. Lastly, at step 230, the system updates the jurisdictional definition file as the underlying configurable transaction array files are refreshed and regulatory environments evolve. This updating happens through the API data component 175 of the database 170 by updating the transaction arrays through the jurisdiction logic network 160. For example, the system may connect to the financial regulation engine 165 in one or more countries to request and extract updated regulations. The updated regulations may be automatically applied to the jurisdictional definition system 105.

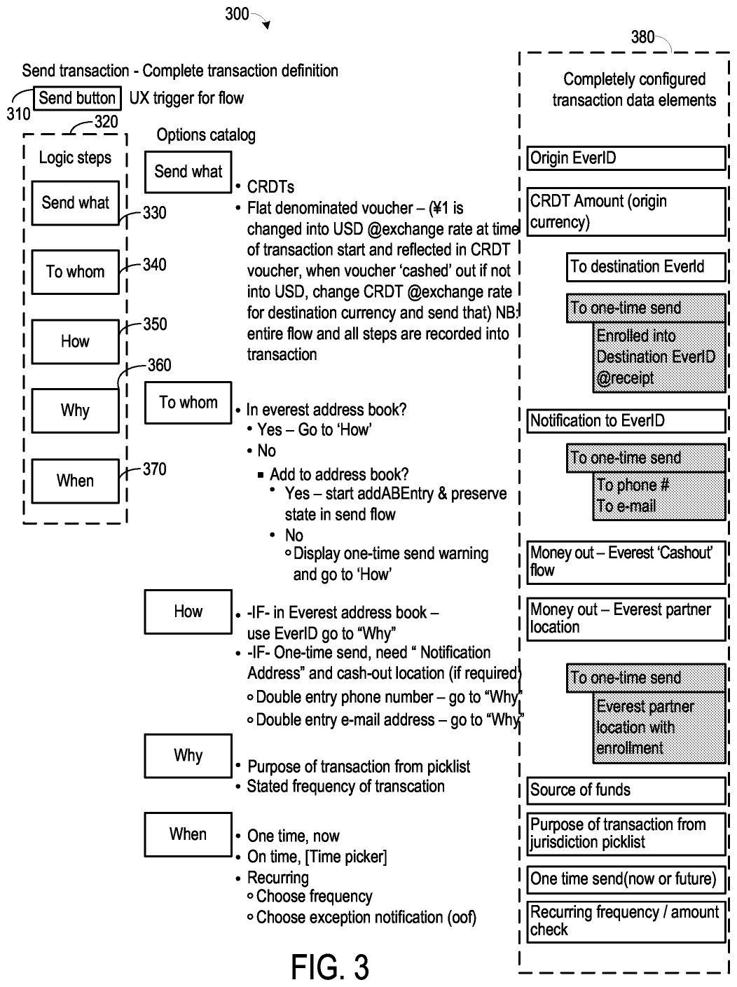

Referring to FIG. 3, FIG. 3 illustrates the data elements 300 that the system needs to start creating the configurable transaction array. The data elements 300 includes a send button 310, logic steps 320, and a completely configured transaction data elements 380. The send button 310 is a UX trigger for flow which sends the logic steps 320 to the sender device 150 in order to retrieve relevant transaction information to build up the transaction array with the help of the processor 125 and the data extraction module 135. The UX trigger may be linked to one or more functions that retrieve relevant information and regulations for a transaction request. Once pressed, the UX trigger may implement the one or more functions. Once the logic steps 320 ask a series of questions and receives the corresponding answers, the completely configured transaction data elements 380 automatically fills the answers of the logic step's 320 questions. For example, the logic steps 320 may send a request to the sender or receiver of a transaction request for information required to process the decision tree. In various embodiments, the logics steps 320 may connect to the sender or receiver through an API to automatically retrieve information to answer the series of questions.

An embodiment of the logic steps 320 comprises of a “send what” question 330, “to whom” question 340, “how” question 350, “why” question 360, and a “when” question 370. The “send what” question 330 may determine whether the financial transaction is a credit, flat denominated or any other form of transaction. The “to whom” question 340 determines who the receiving party is and what kind of receiver device 155 the jurisdiction logic system is dealing with. The “how” question 350 determines the sender device and its corresponding process in which the sender would like to perform the financial transaction. The “why” question 360 determines the purpose of the transaction and the corresponding reasons associated with the international financial transaction. Lastly, the “when” question 370 determines the stated frequency of the transaction and whether it is a onetime transaction or a recurring transaction; and if recurring, a frequency of the recurring financial transaction. Once the answers to these questions are provided by the sender device 150, the system maps this information into the completely configured transaction data elements 380. The mapped information may allow the decision tree to be processed and determine whether the transaction request will succeed or fail.

In the embodiment of the mapped information shown in FIG. 3, the various fields of the completely configured transaction data elements 380, going from top to bottom, include an Origin name, an amount, a transmission to be made to a destination, which includes a frequency of transaction and whether the destination is enrolled in the origin's database. The various fields include a notification to the origin, which includes the aforementioned frequency of transaction as well as contact information for the destination. Additionally, the various fields include the identity of the party sending money and the identity of the party receiving money. The party receiving money includes fields for the frequency of transaction and the enrollment status of the receiving party. Additional fields in the completely configured transaction data elements 380 include the source of funds, the purpose of the transaction s from jurisdiction picklist, whether the requested transaction is a one-time send, the frequency of transaction, and amount of transaction. The various fields of the completely configured transaction data elements 380 may be used to fill in details that will later be used to process the decision tree.

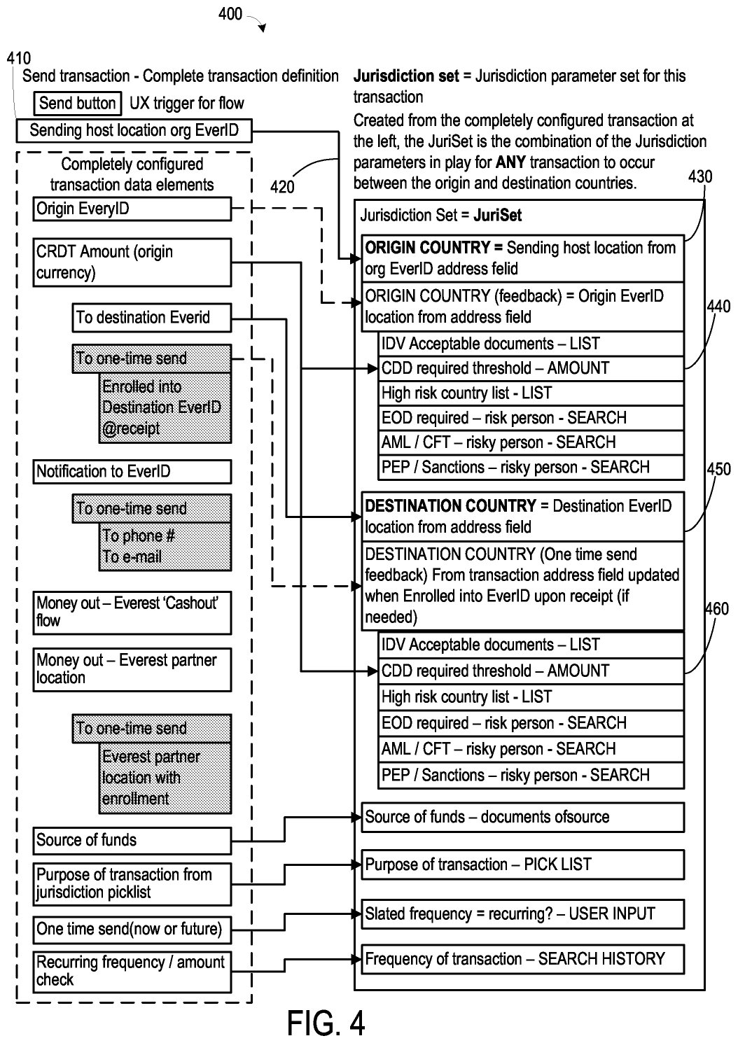

Referring to FIG. 4, FIG. 4 illustrates the mapping 400 of the jurisdiction logic system transaction details into the configurable transaction array. The mapping 400 includes a sending host 410, completely configured transaction data elements 380, linking component 420, origin country 430, origin country's customer due diligence (CDD) requirement 440, destination country 450, and a destination country's CDD requirement 460. Created from the completely configured transaction data elements 380, the transaction array is the combination of the parameters in play for any transaction to occur between the origin and destination countries.

The sending host 410 allows the information to be mapped out to the transaction array through the linking component 420. The linking component 420 selectively maps the various fields of the completely configured transaction data elements 380 to the configurable transaction array. The origin country 430 may be determined through the location of the sender device 150. The regulations associated with the origin country may be extracted from the financial regulation engine 165 and appended to an associated location regulations variable. Responsive to the origin country 430 and its associated location's regulations, the transaction array creates an origin country's CDD requirement 440, which is the customer due diligence information that is in accordance with the sender. The customer due diligence information may include questions or queries for information that verifies that regulations or the origin country are being followed. For example, a regulation concerning a source of certain materials may be converted into a question that requires verifiable proof of a source of the materials. Similarly, a regulation that requires that products be produced by free labor may be converted into a question that requires verifiable proof that products in the requested transaction were produced by humane labor conditions.

Moreover, the destination country 450 will be determined through the answer that is provided by the user to the to whom question 340 of the logic steps 320. Like the regulations of the origin country, regulations for the destination country may be extracted from the financial regulation engine 165 into an associated location's regulations.

Responsive to the destination country 450 and its associated location's regulations, the transaction array creates a destination country's CDD requirement 460 which is the customer due diligence information that is in accordance with the receiver of the transaction. Like the regulations of the origin country, questions and queries based on the destination country may be converted from the regulations that were extracted from the financial regulation engine 165. Moreover, various regulations may be dependent on both the origin country and the destination country. For example, a treaty between the origin country and the destination country may dictate specific regulations between the origin country and the destination country. The linking component 420 may check for such regulations that depend on both the origin and destination countries and map those regulations to the configurable transaction array.

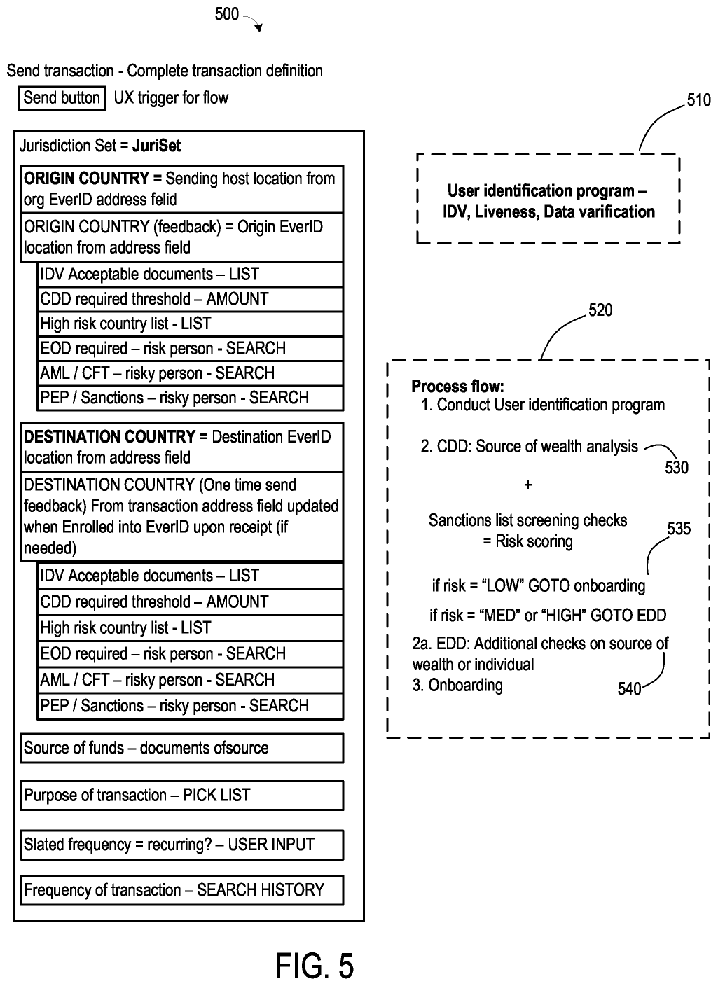

Referring to FIG. 5, FIG. 5 illustrates an overview 500 of the configurable transaction array. The overview 500 includes a customer identification program 510 and a process flow 520 which describes how the customer identification program 510 works. The customer identification program 510 includes data such as identity verification (IDV), liveness, and data verification. This information will allow the due diligence process to be conducted by the jurisdiction logic system. The process flow 520 includes customer identification program 510, Source of wealth analysis 530, risk scoring 535, and enhanced due diligence (EDD) 540. By processing the customer identification program 510, the system will be able to further conduct a source wealth analysis 530 which determines user due diligence in accordance to the user.

The system creates empty fields that, when filled, may be used to determine whether various aspects of the due diligence process have been satisfied. For example, to provide IDV, the system may provide a field that may be filled with specific information. In one example, an IDV may be satisfied by valid credit card information regarding an individual. The credit card information may be registered in the field whereby the card number could be verified to match a given identity. The customer wealth analysis may be similarly conducted. There, an empty field may be created to be filled with various financial data that relates to the transaction history of the sender. In one example, past transactions on the sender and receiver are registered as the wealth analysis.

Once the wealth analysis is processed, the system will be able to conduct a risk scoring 535 mechanism to predict a risk level associated with the user. If the risk level is low, the system will proceed to onboarding and complete the transaction. However, if the risk level is medium or high, then the system will further conduct EDD 540 which is an enhanced due diligence to conduct additional checks on source of wealth or individual. In one example of risk scoring, the system may determine whether the wealth analysis indicates that the sender or receiver in the requested transaction have past transactions that surpass a threshold for transferring wealth across state boundaries. The amount of the currency that was transferred across state boundaries may indicate the risk level directly proportionate to the amount of currency. In another example of risk scoring, the risk level may be based on the types of past transactions in addition to the quantity of past transactions. For instance, past transactions with origin or destination countries that are flagged as a source of money laundering may indicate a higher risk than past transactions with countries that are not associated to known money laundering transaction vectors.

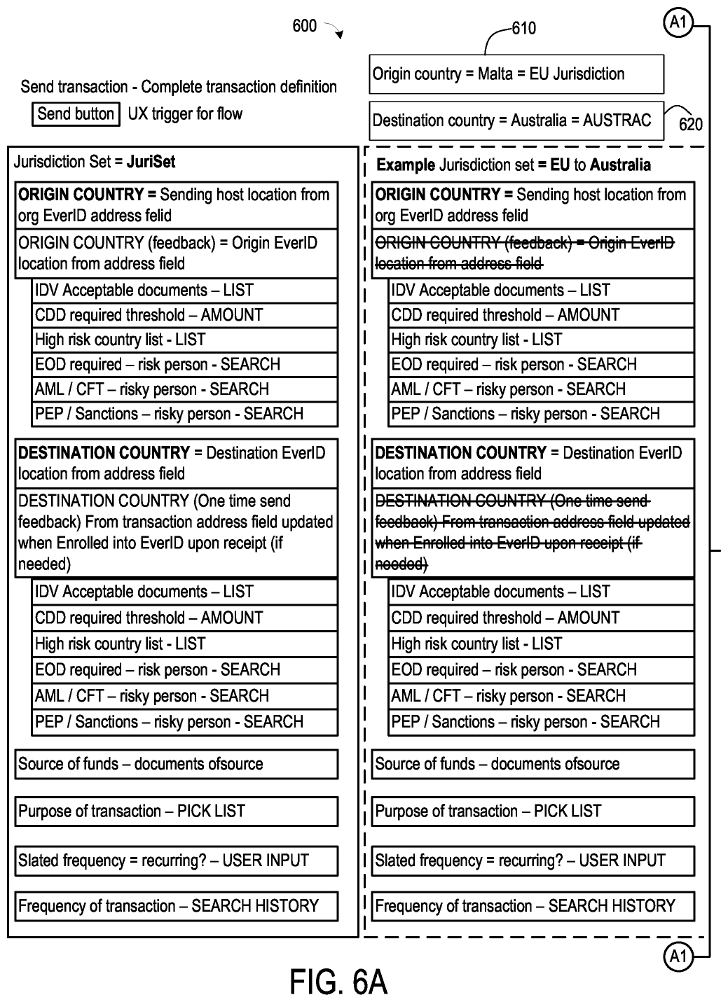

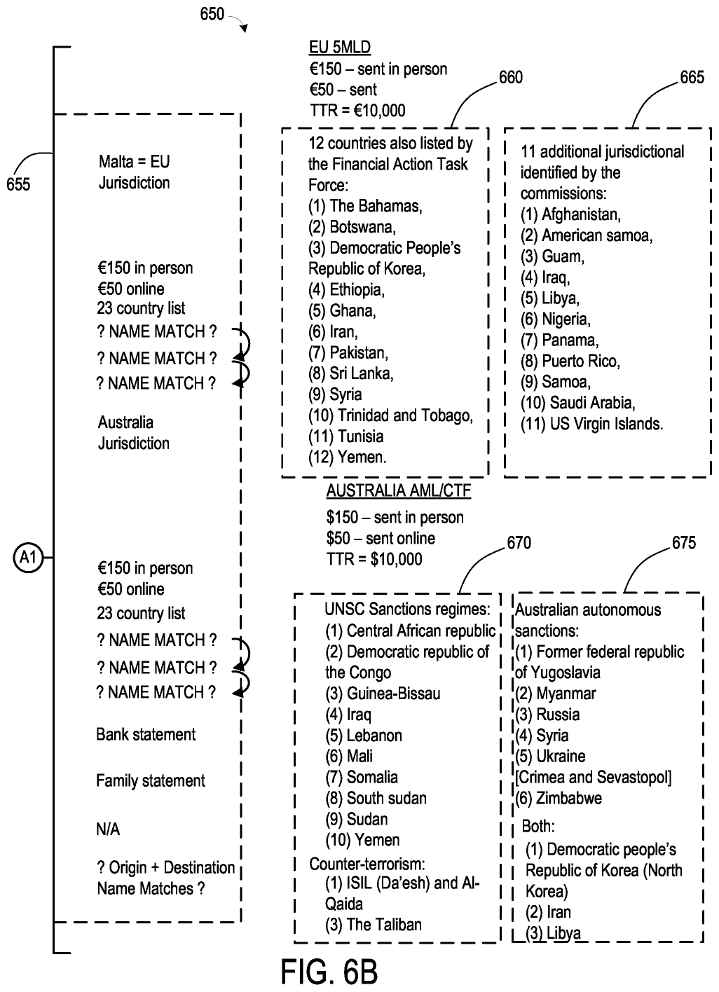

Referring to FIG. 6A, FIG. 6A illustrates an example 600 of a configurable transaction array that can be created. The two countries that are illustrated in the example 600 are origin country Malta 610 and a destination country Australia 620. The regulations associated with Malta 610 and Australia 620 are retrieved from the financial regulation engine 165 which stores all the regulations and legislations associated with each country regarding financial transactions overseas. The example 600 further illustrates how the information of Malta 610 is being inserted into the transaction array as the origin country 430 and how the origin country's CDD requirement 440 will further be conducted in accordance to Malta's regulations.

Note that the “ORIGIN COUNTRY” is determined from the sending host location rather than the EverID location address field. The “DESTINATION COUNTRY” is determined from the EverID location address field rather than the transaction address field. The example 600 also illustrates how the information of Australia 620 is being inputted into the transaction array as the destination country 450 and how the destination country's CDD requirement 460 will further be conducted in accordance to Australia's regulations.

Referring to FIG. 6B, FIG. 6B illustrates further details 650 regarding the previous example of a configurable transaction array being conducted. The further details 650 includes jurisdiction data 655 relevant to the associated sender and receiver countries. The further details 650 also includes a financial action task force list 660, jurisdictional commissions list 665, UNSC sanctions regimes list 670, and an Australian autonomous sanctions list 675. These 4 category lists allow the system to analyze the sender country and the receiver country in a more efficient way. The financial action task force list 660 includes 12 countries such as the Bahamas, Botswana, Democratic People's Republic of Korea, Ethiopia, Ghana, Iran, Pakistan, Sri Lanka, Syria, Trinidad and Tobago, Tunisia, and Yemen. If the sender device 150 or the receiver device 155 is within any of the 12 listed countries in the financial action task force list 660, then the decision tree module 115 and the financial regulation engine 165 will act according to the financial task force's regulations. The jurisdictional commissions list 665 includes 11 countries such as Afghanistan, American Samoa, Guam, Iraq, Libya, Nigeria, Panama, Puerto Rico, Samoa, Saudi Arabia, and US Virgin Islands. If the sender device 150 or the receiver device 155 is within any of the 11 listed countries in the jurisdictional commissions list 665, then the decision tree module 115 and the financial regulation engine 165 will act according to the jurisdictional commission's regulations.

Moreover, the UNSC sanctions regimes list 670 that can include 10 countries such as Central African Republic, Democratic Republic of the Congo, Guinea-Bissau, Iraq, Lebanon, Mali, Somalia, South Sudan, Sudan, and Yemen. If the sender device 150 or the receiver device 155 is within any of the 10 listed countries in the UNSC sanctions regimes list 670, then the decision tree module 115 and the financial regulation engine 165 will act according to the UNSC sanctions regime's regulations. Lastly, the Australian autonomous sanctions list 675 includes 6 countries such as the Former federal republic of Yugoslavia, Myanmar, Russia, Syria, Ukraine, and Zimbabwe. If the sender device 150 or the receiver device 155 is within any of the 6 listed countries in the Australian autonomous sanctions list 675, then the decision tree module 115 and the financial regulation engine 165 will act according to the Australian sanction's regulations. The categories described above allows the jurisdiction logic system to analyze the sender and the receiver country in a more efficient way.

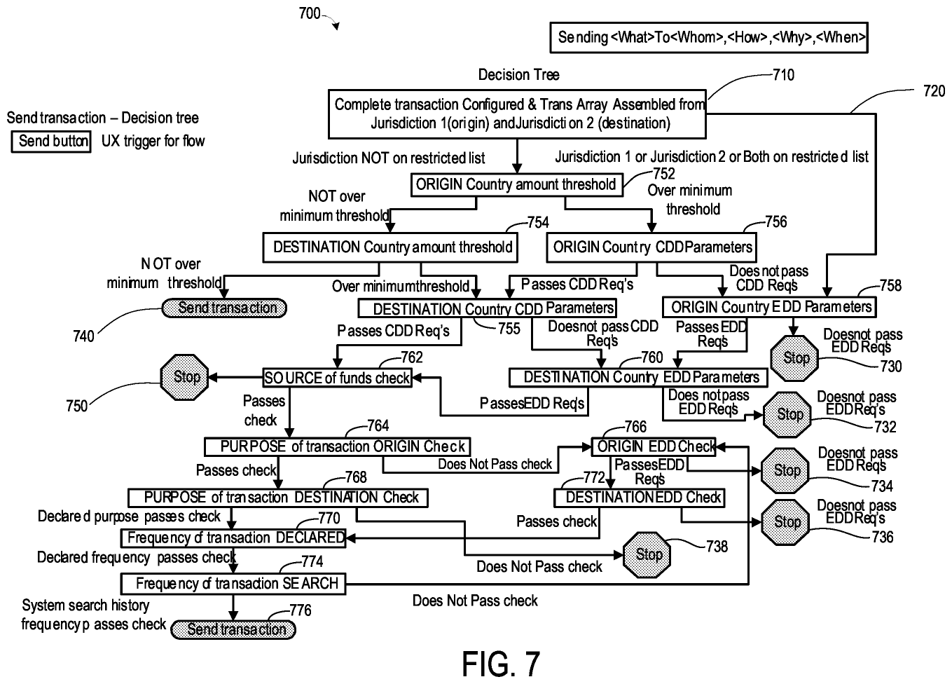

Referring to FIG. 7, FIG. 7 illustrates a decision tree 700 that is populated by the configurable transaction array. The decision tree 700 comprises of one or more internal nodes 710, branch 720, send transaction decisions 740, stop transaction decisions 750, and errors at node 730 which leads to the stop decision. The requested transaction between a sender device 150 and receiver device 155 is processed by populating the decision tree 700 with the information from the transaction array 110. As the system 100 processes the information through the decision tree, each branch decision is recorded as an encoded marker into the transaction. The decision tree 700 uses a tree-like model of decisions and their possible consequences and outcomes.

One of the purposes of the decision tree 700 is to automate the financial regulatory compliance by processing conditional control statements that gets populated with the data that is extracted from the transaction arrays. The decision tree 700 is a flowchart-like structure in which each internal node 705 represents a predictive test, each branch 720 represents the direction that guides the outcome of the test, and the paths from one node to another node determines whether the transaction will be stopped or will proceed. By parsing through the internal nodes 710 through the branches 720 with the guidance of decision factors, responsive to determining that the transaction will fail, the decision tree 700 will make a stop transaction decision at node 750 and will further determine the remediation steps that will be required for the transaction to proceed. In various embodiments, the remediation steps include a suggestion of alternative countries with which to perform the transaction. However, if the parsing leads to a send transaction decision at node 740, then the system may perform the transaction. This decision tree 700 will allow this jurisdiction logic system to empower predictive models with high accuracy and ease of interpretation.

The decision tree analysis starts at the top node and propagates through various decision nodes until the analysis reaches a node that can conclude the analysis. The decision tree may include several such conclusion nodes. The first node 710 determines that the configurable transaction array is fully assembled and filled for both the origin location and the destination location. If the criteria for the first node are satisfied, the analysis propagates to the next node 752. If not, the analysis propagates instead to node 758 for enhanced due diligence. Node 752 determines whether the amount of the transaction exceeds a threshold for the origin country. If not, the analysis moves on to the next node 754. There, like node 752, node 754 determines whether the transaction amount exceeds a threshold for the destination country. The thresholds for node 752 and node 754 may be set by the linking component 420. If node 754 determines that the amount is not over the threshold, the requested transaction may be automatically sent at node 740. However, if node 754 determines that the amount is over the threshold, the analysis propagates to node 755 to determine whether the requested transaction satisfies the destination country's customer due diligence parameters.

On the other hand, if node 752 determines that the transaction amount exceeds the threshold for the origin country, the analysis proceeds to node 756, which determines whether the requested transaction satisfies the origin country's due diligence parameters. If the analysis at node 756 for due diligence fails, the analysis propagates to node 758 for enhanced due diligence for the origin country. If node 756 determines a pass, the analysis propagates to node 755 for a determination of customer due diligence with respect to the destination country. If the analysis at node 758 fails, the analysis propagates to node 730 and the transaction request is rejected.

If node 756 determines that the requested transaction passes the origin country's due diligence requirements, the analysis propagates to node 760 to determine whether it passes the destination country's due diligence requirements. If the analysis at node 760 fails, the analysis is stopped at node 732 and the transaction request is rejected. If the analysis at node 760 passes, the analysis propagates to node 762, which determines whether the requested transaction passes a source of funds check. If it passes the source of funds check, the analysis moves on to node 764 to determine whether the purpose of the requested transaction is satisfactory. If node 762 determines that the source of funds fails, the analysis is stopped at node 750 and the transaction is rejected.

If the analysis at node 764 determines that the requested transaction fails based on the stated purpose of the transaction, the analysis moves on to node 766, which does an enhanced due diligence check based on the origin country's regulations. If the analysis at node 766 fails, the analysis is stopped at node 734 and the transaction request is rejected. On the other hand, where the analysis at node 764 passes and node 764 determines that the purpose of the transaction with regard to the origin is satisfactory, the analysis moves on to node 768, which determines whether the purpose of the transaction with regard to the destination is satisfactory. If the analysis at node 766 for the enhanced due diligence on the origin country passes, the analysis moves on to node 772 to perform an enhanced due diligence check based on the destination country.

If the analysis at node 768 fails, the analysis propagates to node 738 and the requested transaction is rejected. Alternatively, when the analysis at node 768 passes, the analysis propagates to node 770 to check a frequency of declared transactions. Similarly, the analysis may also propagate to node 770 from node 772 if node 772 determines that the requested transaction passes a check for enhanced due diligence based on the destination country's requirements. If the analysis at node 770 passes, the analysis moves on to node 774 to determine whether a search of the frequency of transactions passes a check. If the analysis at node 774 passes, the requested transaction is approved and automatically sent at node 776. However, if node 774 determines that the search of frequency of transactions does not pass, the analysis propagates to node 766 for enhance due diligence analysis. If the enhanced due diligence analysis at any of node 758, node 760, node 766, or node 772 fails, the transaction is stopped at one of node 730, node 732, node 734, or node 736 respectively.

The method and system for automating financial regulatory compliance may be performed in a variety of embodiments, some of which are described herein. The disclosed subject matter is intended to embody all variations including those listed in this disclosure. The method and system for automating financial regulatory compliance should not be limited by the described embodiments in any way. Instead, the invention should be limited by the appended claims.

1. A method for automating financial regulatory compliance, comprising:
generating, by a mapping system, a jurisdictional definition file based on a plurality of financial regulatory requirements for a plurality of countries;
responsive to receiving a transaction request, generating, by a jurisdiction logic system, a configurable transaction array for the transaction request that is a subset of the jurisdictional definition file based on a sender information and a receiver information;
mapping, by the jurisdiction logic system, the sender information and the receiver information into the configurable transaction array;
determining, by the jurisdiction logic system, whether the transaction request will succeed or fail by using a decision tree that is populated by the configurable transaction array.

2. The method of claim 1, wherein the sender information further comprises a sender identification information, a sender country, and a type of transaction.

3. The method of claim 1, wherein the receiver information further comprises a receiver identification information, and a receiver country.

4. The method of claim 1, wherein the configurable transaction array further comprises a series of logic step questions to extract information regarding the sender country, receiving country, reason of transaction, type of currency, and other details associated with the transaction.

5. The method of claim 1, responsive to determining that the transaction will fail further comprising determining, by the jurisdiction logic system, remediation steps that will be required for the transaction to proceed.

6. The method of claim 1, further comprising performing the transaction request responsive to determining that the transaction will succeed.

7. The method of claim 1, further comprising periodically updating the jurisdictional definition file as the underlying configurable transaction array files are modified when there is a change in the financial regulatory requirement.

8. A system for automating financial regulatory compliance, comprising:
a mapping system configured to generate a jurisdictional definition file based on a plurality of financial regulatory requirements for a plurality of countries;
responsive to receiving a transaction request, a jurisdiction logic system configured to generate a configurable transaction array for the transaction request that is a subset of the jurisdictional definition file based on a sender information and a receiver information;
wherein the jurisdiction logic system is configured to map the sender information and the receiver information into the configurable transaction array;
wherein the jurisdiction logic system is configured to determine whether the transaction request will succeed or fail by using a decision tree that is populated by the configurable transaction array.

9. The system of claim 8, wherein the sender information further comprises a sender identification information, a sender country, and a type of transaction.

10. The system of claim 8, wherein the receiver information further comprises a receiver identification information, and a receiver country.

11. The system of claim 8, wherein the configurable transaction array further comprises a series of logic step questions to extract information regarding the sender country, receiving country, reason of transaction, type of currency, and other details associated with the transaction.

12. The system of claim 8, responsive to determining that the transaction will fail, further comprising determining, by the jurisdiction logic system, remediation steps that will be required for the transaction to proceed.

13. The system of claim 8, further comprising performing the transaction request responsive to determining that the transaction will succeed.

14. The system of claim 8, further comprising updating the jurisdictional definition file as the underlying configurable transaction array files are modified when there is a change in the financial regulatory requirement.

15. A method for automating financial regulatory compliance, the method comprising:
generating, by a mapping system, a jurisdictional definition file based on a plurality of financial regulatory requirements for a plurality of countries;
responsive to receiving a transaction request, generating, by a jurisdiction logic system, transaction data comprising one or more questions that are based on a sender information and a receiver information of the transaction request; and
determining that the transaction request will succeed or fail based on a decision tree that is generated from the transaction data.

16. The method of claim 15, further comprising:
identifying one or more customers in the transaction data;
performing a source wealth analysis on the one or more customers;
determining a risk score based on the source wealth analysis for the one or more customers; and
determining that the risk score is below a threshold to proceed with the transaction request.

17. The method of claim 15, further comprising determining whether a transaction request can be remedied responsive to a determination that the transaction request will fail.

18. The method of claim 17, further comprising determining one or more remedial steps based on the determination that the transaction request will fail.

19. The method of claim 17, wherein the remedial steps comprise providing additional transaction information for the transaction request.

20. The method of claim 15, wherein the transaction request comprises an array of two or more transactions.
